(19) United States
(12) Patent Application Publication
(10) Pub. No.: US 2005/0183520 A1
(43) Pub. Date: Aug. 25, 2005

(54) VOC groundwater sampler

(76) Inventor: Richard Barr Learned, North Chatham, MA (US)

Correspondence Address: Richard Barr Learned, 26 Raccoon Run, P.O. Box 314, North Chatham, MA, 02650, US

(21) Appl. No.: 11/042,242

(22) Filed: Jan. 26, 2005

Related U.S. Application Data
(60) Provisional application No. 60/547,343, filed on Feb. 25, 2004.

(51) Int. Cl. G01N 1/12

(52) U.S. Cl. 73/864.51

(57) ABSTRACT

The present invention is directed to a method and apparatus for manually sampling a fluid source in a well, comprising an act of lowering a tube containing containers and container caps into a fluid in the well to allow said fluid to pass from the well into the tube to fill at least a portion of the tube such that the containers and container caps are submerged in the fluid, retrieving the tube; and closing the containers with the container caps while still submerged in the fluid.

### CROSS REFERENCE TO RELATED APPLICATIONS

This application claims the benefit of Provisional Patent Application No. 60/547,343, filed Feb. 25, 2004.

### STATEMENT REGARDING FED SPONSORED R&D

Not applicable.

### REFERENCE TO SEQUENTIAL LISTING, A TABLE, OR A COMPUTER PROGRAM LISTING APPENDIX

Not applicable.

### FIELD OF THE INVENTION

The present invention relates to methods, apparatus, and systems for sampling of a fluid source.

### BACKGROUND OF THE INVENTION

The present invention relates to a well and groundwater sampling. Wells are used in the environmental and water supply industries, among other things, to collect samples of groundwater for chemical analysis. A typical well, shown in FIG. 1, is comprised of a slotted section of pipe 1 (the “well screen”) located at the bottom of the well, a well point 2 which plugs the bottom of the well screen 1, and sections of solid pipe 3 (the “riser pipe”) which thread onto the well screen 1 and each other to bring the well to the ground surface 4. The slots in the well screen 1 are narrow enough (e.g., on the order of hundredths of an inch) to keep out soil particles, but allow in groundwater. The water level within a well having a portion of a well screen 1 above a water table 5 (e.g., water table well 6) is the same as the level of the water table 5 since atmospheric pressure alone is acting equally on both. If the entire well screen 1 is located beneath the water table 5 (e.g., deep well 7), additional pressures act on the groundwater. The pressures acting on a unit measure of groundwater are referred to as “head pressure”. Groundwater will flow from areas of high head pressure to areas of low head pressure. Groundwater entering a deep well 7 will usually flow upward into the riser pipe 3 until it reaches equilibrium. The water level at equilibrium is sometimes referred to as the piezometric surface 8. The piezometric surface 8 in a deep well 7 is not necessary the same as the water table 5.

Significant mixing or agitation of the groundwater in a well during sample collection can result in loss of volatile compounds (volatiles) to the air column 9, or introduction of contaminant-laden particulates or colloids into the sample. Conventional sample collection methods also may release volatiles to the atmosphere during the transfer of the groundwater into sample containers at the ground surface 4. One conventional method that may release volatiles into the atmosphere consists of the use of a bailer. Bailers are typically short tubes that with a check ball inside that will either pass fluid through the bailer or retain fluid. Conventional check balls have a specific gravity greater than water, but can be displaced by the force of the inflowing water. Therefore, as long as the bailer sinks, groundwater passes through the bailer. When the bailer is retrieved, the check ball blocks the bottom opening and retains the water in the bailer. The collected water must then be transferred (typically by pouring) from the bailer into laboratory-acceptable containers at the ground surface. This is when significant loss of volatiles may occur due to: 1) mixing and agitation of the water as it is poured into containers; 2) the water is transferred slowly and as a relatively thin “ribbon” or stream which creates a large cumulative surface area from which volatiles can escape; and 3) the time from when the bailer is removed from the groundwater until the containers are filled at the ground surface is relatively lengthy. The present invention comprises a method and apparatus to sample groundwater that minimizes loss of volatiles and entrainment of particulates and colloids.

### BRIEF SUMMARY OF THE INVENTION

One illustrative embodiment of the invention is directed to a method for manually sampling a fluid source in a well, comprising an act of lowering a tube containing laboratory-acceptable containers (hereinafter containers) and container caps into a fluid in the well to allow said fluid to pass from the well into the tube to fill at least a portion of the tube such that the containers and container caps are submerged in the fluid.

Another illustrative embodiment of the invention is directed to a container open at both ends to allow fluid to pass through.

Another illustrative embodiment of the invention is directed to a container threaded at both ends so that said container can be closed and sealed with threaded container caps.

Another illustrative embodiment of the invention is directed to a method to secure the container caps inside perforated sleeves (hereinafter referred to as sleeves) by binding the sleeves around the container caps with ties.

Another illustrative embodiment of the invention is directed to a method to position a container inside a sleeve so that a gap remains between the container cap and container. The act of leaving a gap allows a fluid to pass through the container.

Another illustrative embodiment of the invention is directed to placing a top sleeve over the threads of a bottom container and resting the top sleeve on the shoulder of the bottom container. The act of so positioning the top sleeve on the bottom container shoulder maintains a gap between the bottom container and the container cap which is bound in the top sleeve. The act of so positioning also allows “stacking” of containers and container caps in series so that a fluid can flow through multiple containers.

Another illustrative embodiment of the invention is directed to a tube comprised of two sections connected at a coupling.

Another illustrative embodiment of the invention is directed to a tube with a floatable check ball that allows fluid in when the tube is lowered (check ball is “unseated”) and prevents fluid from escaping when the tube is retrieved (check ball is “seated”). The check ball has a specific gravity slightly less than the fluid. Therefore, it floats off the “seat” as the tube is lowered into the fluid. This advantageously opens the tube to allow water to pass through unobstructed (i.e., when the tube is lowered), or to allow the water inside the tube to equilibrate (e.g., chemically) with the water in the well (i.e., when the tube is left in place). This also reduces turbulence when the tube is filling since the check ball doesn't constantly sink into the inflowing water as with conventional check balls. The floatable check ball is kept in the bottom portion of the tube by a convex perforated insert that is fitted into the tube near the bottom opening. The convex shape of the insert creates a “pocket” for the floatable check ball to occupy while water is flowing into the tube. This keeps the check ball stationary and also reduces turbulence as the tube fills.

Another illustrative embodiment of the invention is directed to a method for inserting containers and container caps into a section of a tube comprised of separating and rejoining the tube at a coupling.

Another illustrative embodiment of the invention is directed to a method for manually capping containers submerged in a fluid inside of a section of a tube.

### BRIEF DESCRIPTION OF THE DRAWINGS

The drawings are not intended to be to scale. In the drawings, like elements have been given like reference characters.

FIG. 1 is cross-sectional views of: (A) a typical water table well; and (B) a typical deep well.

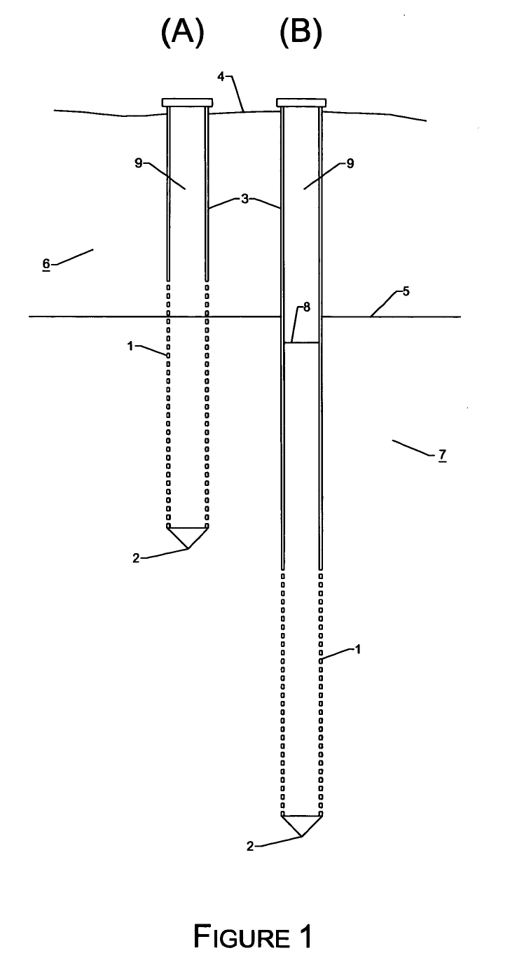

FIG. 2 is cross-sectional views of: (C) the top and bottom sections of a tube; and (D) a top view of a convex perforated insert.

FIG. 3 is views of a container and container caps according to an embodiment of the invention. Cross-sectional views show: (E) the container uncapped (or open); and (F) the container capped (or closed); and (G) is a top view of a container cap.

FIG. 4 is cross-sectional views of containers, container caps, sleeves, ties, and container cap extender according to an embodiment of the invention. The components are shown: (H) separated; (I) with containers and container caps positioned uncapped in sleeves and the container cap extender on the top container cap; and (J) with containers capped in sleeves.

FIG. 5 is cross-sectional views of a tube with containers and container caps positioned uncapped in sleeves, and inserted into the bottom section of the tube. The tube is shown: (K) being lowered into groundwater in a well (floatable check ball unseated); and (L) being retrieved from a well (check ball seated).

FIG. 6 is cross-sectional views of the tube of FIG. 2 containing a fluid with containers, container caps, sleeves, ties, and container cap extender of FIG. 4(I) submerged. (M) shows the containers uncapped; and (N) shows the method for manually capping the containers.

### DETAILED DESCRIPTION

One aspect of the present invention is directed to a method and apparatus that allows a fluid to pass through containers as they are lowered into the fluid, and retains the fluid in the containers when they are retrieved. Another aspect of the present invention is directed to a method and apparatus for closing and sealing containers while the containers are submerged in a fluid. Although these two aspects of the present invention are advantageously employed together in accordance with various illustrated embodiments of the invention, the present invention is not limited in this respect, as each of these aspects of the present invention can be employed separately.

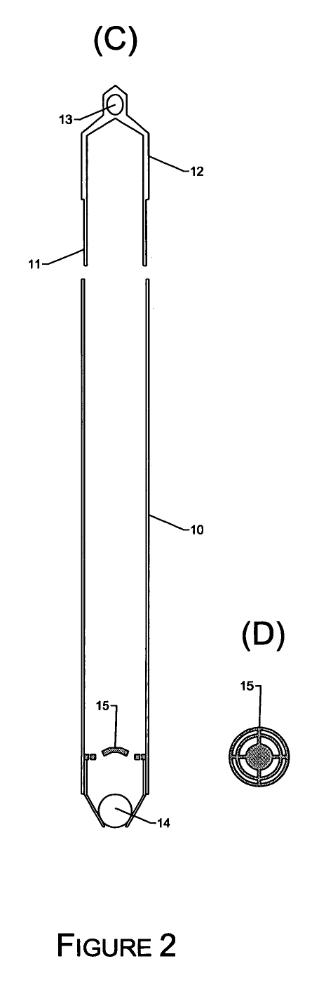

One illustrative embodiment of an apparatus for allowing a fluid to pass through containers as the containers are lowered into the fluid, retaining the fluid in the containers when they are retrieved, and closing and sealing the containers while the containers are submerged in the fluid is shown in FIGS. 2-5. FIG. 2 illustrates a tube 10 separated at a coupling 11. Shown are from left to right: (C) the top section of the tube 12 with coupling 11 and suspension ring 13, the bottom section of the tube 10 with “floatable” check ball 14 and convex perforated insert 15; and (D) a top view of the convex perforated insert 15.

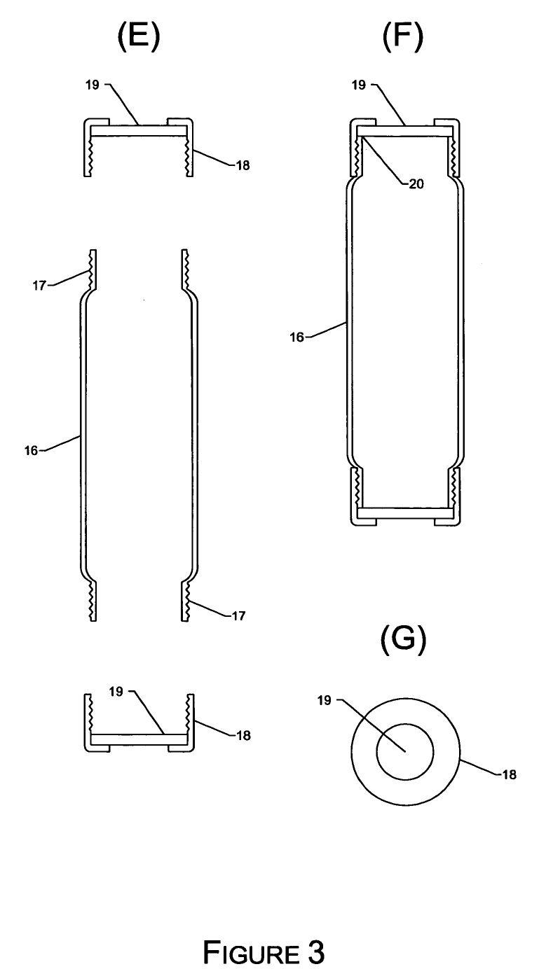

FIG. 3 illustrates, from left to right: (E) a container 16 with open and threaded ends 17 and threaded container caps 18 with septa 19 inside; (F) a closed container 16 sealed by the septa 19 at the interface 20; and (G) a container cap 18 and septa 19 viewed from the top.

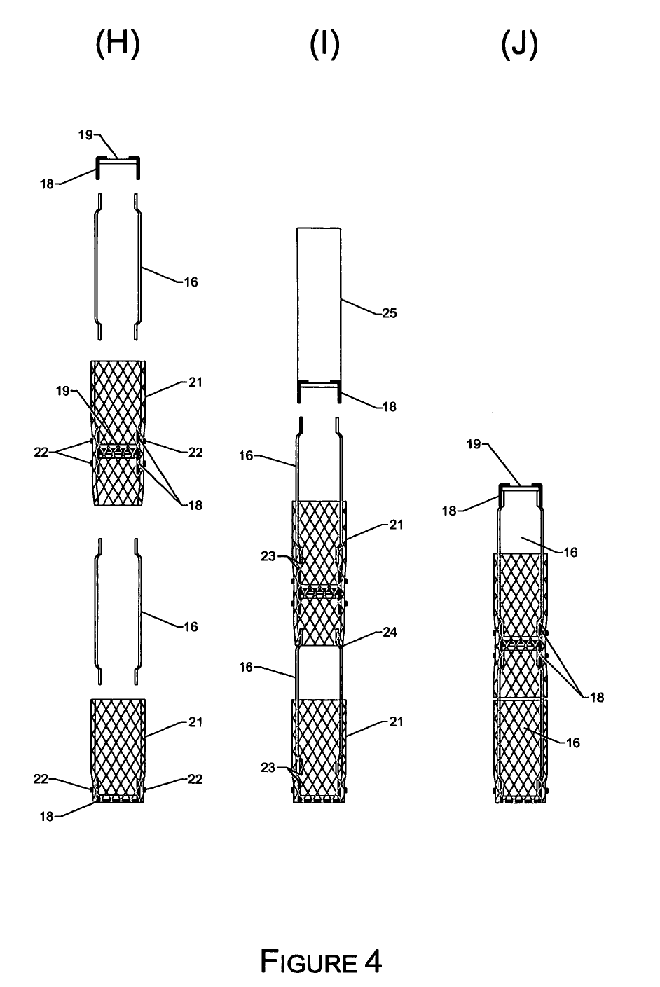

FIG. 4 illustrates, from left to right: (H) containers 16 and container caps 18 bound in sleeves 21 by ties 22; (I) containers 16 positioned in sleeves 21 with a gap 23 between containers 16 and container caps 18, the top sleeve 21 resting on the shoulder 24 of the bottom container 16, and the container cap extender 25 on the top container cap 18; and (J) the containers 16 and container caps 18 threaded together and sealed by the septa 19 at the interface 20.

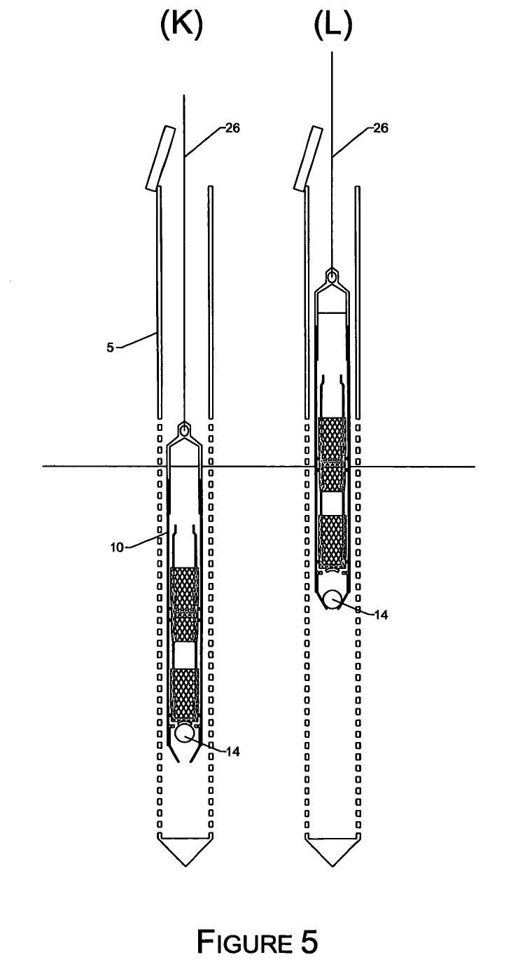

FIG. 5 illustrates, from left to right: (K) a tube 10 being lowered into groundwater in a water table well 5 (floatable check ball 14 unseated) with the containers 16, container caps 18 and sleeves 21 of FIG. 4(I) inserted; and (L) a tube 10 being retrieved from the water table well 5 (check ball 14 seated) with the groundwater retained in the tube 10 and the containers 16 submerged.

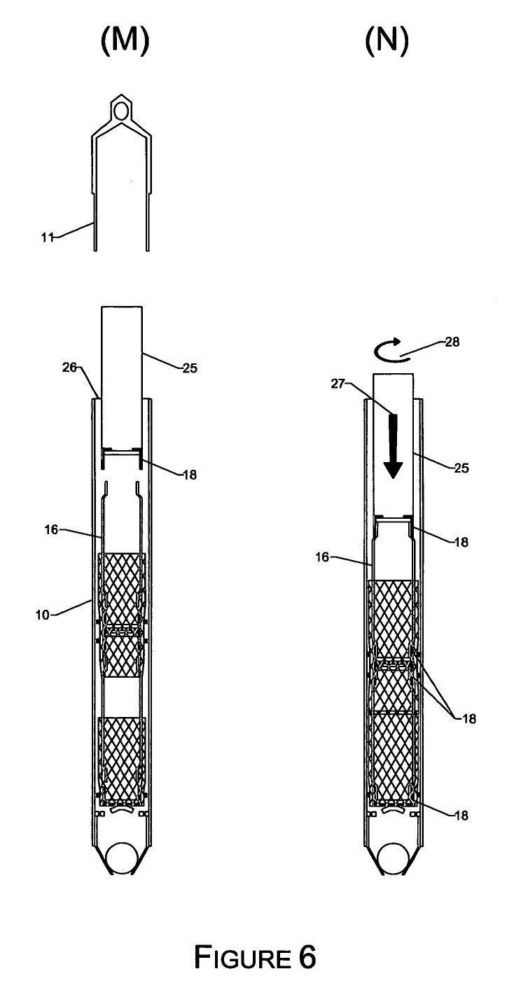

FIG. 6 illustrates, from left to right: (M) a tube 10 separated at a coupling 11 retaining a fluid 26 (i.e., check ball is seated) with a container cap extender 25 fitted onto a top container cap 18 being lowered through the fluid 26 to the top of a container 16; and (N) the containers 16 manually pressed 27 into the container caps 18 by the container cap extender 25 and closed by turning 28 the container cap extender 25.

To collect a groundwater sample using the present invention, the tube 10 is separated at the coupling 11 and containers 16 and container caps 18, positioned in the open arrangement in sleeves 21 (i.e., a gap 23 is left between the containers and container caps) are inserted. The tube sections 10 and 12 are reconnected at the coupling 11 which forms a tight fit with the tube and closes the containers and container caps inside. The top container cap 18 for the top container 16 is fitted onto the top container cap extender 25 and left out of the tube 10. A line 26 is attached to the tube 10 at the suspension ring 13, the tube 10 is lowered on the line 26 into a well and through the groundwater in the well. As the tube 10 sinks water flows in and floats the floatable check ball 14 out of the opening. The convex perforated insert 15 keeps the floatable check ball 14 in the bottom portion of the tube 10. The water flows through the containers 16, and out the top of the tube 12 which is open on the sides. The tube 10 is lowered until it reaches the desired sample depth. Due to the open-ended containers 16 and the floatable check ball 14, the water in the containers 16 is the same as the water in the well at the same depth. Pulling the line 26 up seats the check ball 14 and retrieves the tube 10. The water from the desired sample depth is retained in the tube 10, and hence in the containers 16 by the seated check ball 14. At the ground surface 4, the tube 10 is again separated at the coupling 11. This allows access to the water in the tube 10 and allows the container cap extender 25 with the top container cap 18 to be inserted into the water and placed on the top container 16. The containers 16 are then “collapsed” into the container caps 18 by pushing down on the container cap extender 25. This act also expels any air in the top container caps 18. Alternately, a small hole in the sidewall of the top container caps 18 can be made to release air as the container caps 18 are submerged. Starting with the top container 16, the container caps 18 are then manually threaded onto the containers 16 by turning the container cap extender 25 and alternately squeezing the tube 10 to prevent containers 16 or sleeves 18 from rotating. The ties 22 prevent the container caps 18 from spinning in the sleeves 21. However, the containers 16 can spin in the sleeves 21. Therefore, all of the container caps 18 can be threaded onto the containers 16 by turning the container cap extender 25.

An advantage of the present invention is the open-ended containers can pass water through allowing samples to be collected at any specific depth within a water table or deep well.

Another advantage of the present invention is the floatable check ball, which allows groundwater into the tube except when the tube is retrieved. This advantage over conventional bailers, which rely upon the force of the incoming water to unseat the check ball, results in less turbulence within the tube as the water enters, and allows the bailer to be lowered into the water at a very slow rate, thereby minimizing the displacement of water at the leading tip of the tube 10 to the outside of the tube 10 and maximizing pass-through of the water. When the tube is left in place in a well, this advantage also allows water inside the tube to equilibrate (e.g., chemically) with the water in the well.

Another advantage of the present invention is capping the containers while still submerged significantly reduces loss of volatiles that may occur during the transfer of the water from a conventional sampler to laboratory-acceptable containers.

Another advantage of the present invention is the minimization of mixing or agitating the water column. When first deployed, the tube is lowered very slowly (permissible due to the floatable check ball) through undisturbed water. Therefore, the water in the containers when retrieved is absent any appreciable particulates or colloids.

Another advantage of the present invention is the cost is low enough to use it once, thus eliminating cross-contamination between wells that may occur when equipment is used more than once.

Aspects of the present invention are suited for use with both water table and deep wells. It should be appreciated that although the invention has been described in the context of sampling groundwater, other fluids may alternatively be sampled according to the invention. It should further be appreciated that the materials noted for use in the apparatus described are given for example only. The tube, check ball, containers, container caps, sleeves, ties, and container cap extender may be made from a number of plastics, metals, glass, and other materials that are relatively impermeable and non-reactive.

Having thus described several illustrative embodiments of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

1. A method for manually sampling a fluid source in a well, the method comprising:
lowering a tube with containers and container caps into a fluid source to fill at least a portion of the tube such that the containers and container caps are submerged in the fluid;
retrieving the tube; and
closing the containers with the container caps while still submerged in the fluid.

2. The method of claim 1 wherein lowering the tube into a fluid includes allowing the fluid to pass through the containers.

3. The method of claim 1 wherein retrieving the tube includes retaining the fluid in the containers.

4. An apparatus for collecting a fluid at a specific depth comprised of:
a container open at both ends that allows fluid above the specific depth to pass through as the container is lowered; and
a tube open at both ends which holds the container(s) and container caps.

5. The apparatus of claim 4 wherein the tube has a floatable check ball at the lower opening, which is displaced from the opening by buoyancy, thereby allowing the fluid to pass from the well into the tube.

6. The apparatus of claim 4 wherein the floatable check ball allows the water inside the tube to equilibrate with the physical and chemical conditions of the water in the well.

7. The apparatus of claim 4 wherein the check ball blocks the opening when the tube is retrieved, thereby retaining the fluid in the tube.

8. The apparatus of claim 4 wherein a convex perforated insert fitted into the tube keeps the floatable check ball in the bottom portion of the tube and creates a pocket for the floatable check ball to occupy while the tube is submerged in a fluid.

9. The apparatus of claim 4 wherein the tube can be separated and reattached at the top to insert or remove the containers and container caps.

10. The apparatus of claim 4 wherein the container is threaded at both ends.

11. The apparatus of claim 4 wherein both ends of the container can be capped and sealed.

12. An apparatus for arranging sets of containers and container caps in series comprised of:
perforated sleeves to temporarily hold containers and container caps separate from each other.

13. The apparatus of claim 9 wherein the container caps are bound in the perforated sleeves.

14. The apparatus of claim 9 wherein the containers are not bound in the perforated sleeves but are free to move.

15. A method for closing a container(s) in a tube filled with a fluid using container caps, said container(s) open and threaded at both ends, and arranged with container cap(s) in the open position in a perforated sleeve(s) comprising acts of:
fitting an extender over one container cap not held in the perforated sleeve;
using the extender to lower said container cap into the tube and through the fluid to place it onto the top of a container;
using the extender, pushing the container into the bottom container cap held in the perforated sleeve;
using the extender, threading the container cap fitted to the container cap extender onto the top of the container;
using the container cap extender, turning the container to thread the bottom container cap onto the bottom of the container.
